(19) United States
(12) Patent Application Publication
(10) Pub. No.: US 2019/0310516 A1
(43) Pub. Date: Oct. 10, 2019

(54) LIGHTING DEVICE AND DISPLAY DEVICE INCLUDING THE SAME

(71) Applicant: SHARP KABUSHIKI KAISHA, Sakai City (JP)

(72) Inventors: YOUZOU KYOUKANE, Sakai City (JP); HISASHI WATANABE, Sakai City (JP); HIROTOSHI YASUNAGA, Sakai City (JP)

(21) Appl. No.: 16/297,331

(22) Filed: Mar. 8, 2019

(30) Foreign Application Priority Data
Apr. 4, 2018 (JP) 2018-072440

(51) Int. Cl. G02F 1/1335

(52) U.S. Cl. CPC G02F 1/133605; G02F 2001/133607; G02F 1/133606; G02F 1/133603

(57) ABSTRACT

A lighting device includes: a hoard on which a plurality of light emitting elements is arranged in a matrix; and a reflection member provided on the hoard and having a plurality of apertures. The plurality of apertures is each superimposed on a corresponding one of the plurality of light emitting elements. Parts of the reflection member, which face respectively the plurality of light emitting elements, have a height size that is equal to or substantially equal to a height of the plurality of light emitting elements.

### CROSS-REFERENCE TO RELATED APPLICATION

The present application claims priority under 35 U.S.C. § 119(a) to Japanese Patent Application No. 2018-072440 filed on Apr. 4, 2018, the entire contents of which are incorporated herein by reference.

### BACKGROUND OF THE INVENTION

### Field of the Invention

The present invention relates to a lighting device such as a backlighting device, and a display device including the same.

### Description of the Related Art

Lighting devices such as a backlighting device typically include so-called edge-lit type devices and so-called direct-lit type devices. In the edge-lit type device, a light guiding panel is provided behind a display element such as a liquid crystal panel, and a plurality of light emitting elements such as light emitting diodes (LEDs) are arranged along the edge of the light guiding panel. Light is emitted from the light emitting elements through the light guiding panel and illuminates the slim display element entirely and uniformly. In the direct-lit type device, a plurality of light emitting elements is arranged behind a display element. Light is emitted from the light emitting elements behind the display element and illuminates the display element entirely and uniformly. The edge-lit lighting device can decrease its thickness by making the light guiding panel thinner, however, such a structure deteriorates the image quality in respect of luminance, contrast and the like.

In contrast, the direct-lit type lighting device is mainly adopted to products that seek for high luminance and high contrast, such as televisions and digital signage devices, by controlling the amount of light emitted from the light emitting elements individually or for each region (known as local dimming control). Recently, the use of the direct-lit type lighting devices has expanded to in-vehicle compact display devices that operate under a wide range of temperature environments.

The direct-lit type lighting devices can improve the image quality in respect of luminance, contrast and the like thanks to the local dimming control. However, in order to operate the direct-lit type lighting devices under a specific high-temperature environment, there remain the following problem.

FIGS. 19 to 26 are explanatory views for describing the problem in using a conventional direct-lit type lighting device 5 under a specific high-temperature environment. FIG. 19 is a schematic cross-sectional view illustrating the conventional direct-lit type lighting device 5. FIG. 20 is a schematic cross-sectional view illustrating a configuration inn which light L is diffused by a diffuser panel 6 and a reflection member 4 of the lighting device 5 shown in FIG. 19. FIG. 21 is a schematic perspective view illustrating one example in which the reflection member 4 is provided on a board 2 on which a plurality of light emitting elements 1 is arranged in a matrix. FIG. 22 is a schematic cross-sectional view illustrating a distance D between each rim 3a of a corresponding aperture 3 in the reflection member 4 and the light emitting element 1. FIG. 23 is a schematic cross-sectional view illustrating the positional relationship between the aperture 3 and the reflection member 4 in the initial state. FIG. 24 is a distribution map indicating a luminance distribution of the lighting device 5 in the initial state. FIG. 25 is a schematic cross-sectional view illustrating the positional relationship between the aperture 3 and the reflection member 4 after the lighting device is left under a high-temperature environment. FIG. 26 is a distribution map indicating a luminance distribution of the lighting device 5 after the lighting device is left under a high-temperature environment. In FIGS. 23 and 25, the diffuser panel 6 is omitted. FIGS. 24 and 26 indicate that the luminance decreases as the density decreases.

As shown n FIGS. 19 to 21, the conventional direct-lit type lighting device 5 includes: a board 2 on which a plurality of light emitting elements 1 such as LEDs is arranged in a matrix; and a reflection member 4 provided on a surface of the board 2 on which the light emitting elements 1 are mounted. In the reflection member a plurality of apertures 3 is formed so as to expose, individually, the plurality of light emitting elements 1. The lighting device 5 also includes a diffuser panel 6 that is formed so as to face the surface of the board 2 on which the light emitting elements 1 are mounted. A white resist 2a (specifically, white ink) is applied onto the board 2. In order to further improve the efficiency in the use of the light L, the reflection member 4 is provided on the board 2 coated with the white resist 2a. The reflection member 4 has a white reflection surface 4a that exhibits excellent reflectivity of the light L. The diffuser panel 6 has a function of diffusing the light L from the light emitting elements 1, the white resist 2a and the reflection member 4.

In the lighting device 5, the light L reflected by the diffuser panel 6 is reflected in both a first reflection region a where the white resist 2a on the board 2 is exposed and a second reflection region 6 on the reflection member 4, as shown in FIG. 22. The optical reflectance in the first reflection region a is normally between about 70 to 80% because the white resist 2a cannot be made any thicker. On the other hand, the optical reflectance in the second reflection region 6 is normally about 95% or higher because the reflection member 4 can be made thicker. Therefore, if the dimension of the first reflection region a is smaller, that is, if the distance D between the rim 3a (an inner peripheral surface) of each aperture 3 in the reflection member 4 and a side surface 1b (an outer peripheral surface) of each light emitting element 1 that is positioned within the aperture 3 is smaller, the second reflection region 6 having an optical reflectance of 95% or higher has a greater area. Such an arrangement provides advantageous optical characteristics in respect of the efficiency in the use of the light L. The distance D is set in advance as tolerance, in consideration of variations such as a variation in size of the light emitting elements 1, a variation in forming the apertures 3 in the reflection member 4, a variation in mounting the light emitting elements 1 on the board 2, and a variation in attaching the reflection member 4 to the board 2.

Depending on the environment under which the mounted lighting device 5 is applied or used, the lighting device 5 is required to operate at a wide range of temperature, especially under an environment at a low or high temperature, compared to the case of the televisions and the digital signage devices. In particular, when the lighting device 5 is used for in-vehicle application, it is necessary to suppose, for example, a durable temperature range of −40 to 95° C.

For example, in the initial state of the lighting device 5 as shown in FIG. 23, the reflection sheet 4 allows unobstructed emission of the light L from the light emitting elements 1. Thus, as shown in FIG. 24, the lighting device 5 can provide uniform lighting, for example, at a luminance uniformity of 90%, which is substantially without luminance unevenness. In this context, the luminance uniformity is a ratio of the minimum luminance to the maximum luminance at a plurality of predetermined locations.

On the other hand, if the lighting device 5 is left under a specific high-temperature environment (for example, under an environment at about 95° C.), the reflection member 4 thermally shrinks, and thus heat-shrunk reflection member 4 may cover a light emitting surface 1a, which is an opposite side of the board 2, of the light emitting element 1 as shown in FIG. 25. In this case, the reflection member 4 obstructs outgoing light from the light emitting surface 1a of the light emitting element 1, and darkens the obstructed part, which causes luminance unevenness. In the result, the lighting device 5 has a luminance uniformity, for example, of 68%, and fails to provide uniform illumination as shown in FIG. 26. Thus, the display quality of the display device is eventually degraded. Such cover of the light emitting surface 1a of the light emitting element 1 by the reflection member 4 appears to be caused by heat shrinkage of the reflection member 4 affected by the heat, which is in a slightly floating state due to: cuts of a sheet as the reflection member 4; bending generated by processing of cut apertures 3; and bending of the reflection member 4 itself. This problem becomes pronounced in the case in which the reflection member 4 is a reflection sheet subjected to extending process so as to be extended in a predetermined specific extending direction during manufacture.

In this respect, JP 2013-118117 A suggests a lighting device in which cuts are provided around the apertures in the reflection sheet.

However, the lighting device disclosed in JP 2013-118117 A intends to avoid bending of the reflection sheet due to thermal expansion by providing the cuts. For example, when the reflection sheet thermally shrinks, heat shrinkage occurs all over the reflection sheet irrespective of the cuts around the apertures in the reflection sheet. Eventually, the heat-shrunk reflection sheet covers the light emitting surface of the light emitting element, or comes into contact with or in proximity to the side surface of the light emitting element, which still causes luminance unevenness.

In view of the above-mentioned problem, an object of the present invention is to provide a lighting device that can effectively prevent luminance unevenness and can thereby provide uniform illumination even when a reflection member thermally shrinks under a specific high-temperature environment, and also to provide a display device including the lighting device.

### SUMMARY OF THE INVENTION

In order to solve the above-mentioned problem, a lighting device according to an embodiment of the present invention includes: a board on which a plurality of light emitting elements is arranged in a matrix; and a reflection member provided on the board and having a plurality of apertures. The plurality of apertures is each superimposed on a corresponding one of the plurality of light emitting elements. Parts of the reflection member, which face respectively the plurality of light emitting elements, have a height size equal to or substantially equal to a height of the light emitting elements. Also, a display device according to an embodiment of the present invention includes the lighting device in an embodiment of the present invention.

The present invention can effectively prevent generation of luminance unevenness and can thereby provide uniform illumination even when the reflection sheet thermally shrinks under the specific high-temperature environment.

### BRIEF DESCRIPTION OF THE DRAWINGS

FIG. 1 is a schematic cross-sectional view illustrating a part of a liquid crystal display that is provided with a backlighting device according to the first embodiment.

FIG. 2 is an enlarged schematic plan view illustrating the backlighting device shown in FIG. 1, from which an optical element group and a diffuser panel are removed.

FIG. 3 is a schematic plan view illustrating a difference between apertures formed in a reflection sheet, specifically, between an aperture formed unnecessarily large and an aperture that prevents reduction of efficiency in the use of light.

FIG. 4 is a schematic cross-sectional view illustrating a positional relationship between the aperture and the reflection sheet in an initial state in the backlighting device shown in FIG. 1.

FIG. 5 is a schematic cross-sectional view illustrating the positional relationship between the aperture and the reflection sheet after the backlighting device shown in FIG. 1 is left under a high-temperature environment.

FIG. 6 is a schematic plan view illustrating one example of the aperture in which a first distance in an extending direction of the reflection sheet is larger than a second distance in an orthogonal direction of the reflection sheet.

FIG. 7 is a schematic plan view illustrating one example of the aperture in which the first distance inn the extending direction of the reflection sheet equals or substantially equals the second distance in the orthogonal direction of the reflection sheet.

FIG. 8 is a graph indicating a correlation between the area of the aperture in the reflection sheet and the brightness (luminance).

FIG. 9 is a schematic cross-sectional view illustrating a configuration as one example in which the thickness of the reflection sheet is made smaller than the height of an LED.

FIG. 10 is a schematic cross-sectional view illustrating a configuration as one example in which the thickness of the reflection sheet is made larger than the height of the LED.

FIG. 11 is a schematic cross-sectional view illustrating a configuration as one example in which the thickness of the reflection sheet is equal to or substantially equal to the height of the LED.

FIG. 12 is a graph indicating a correlation among the thickness of the reflection sheet, the height of the LED and the brightness (luminance).

FIG. 13 is a schematic cross-sectional view illustrating a configuration as one example in which the reflection sheet is fixed to an LED board.

FIG. 14 is a schematic cross-sectional view illustrating a configuration as another example in which the reflection sheet is fixed to the LED board.

FIG. 15 is a schematic cross-sectional view illustrating one example of the backlighting device according to the second embodiment.

FIG. 16 is a schematic cross-sectional view illustrating one example of the backlighting device according to the third embodiment.

FIG. 17 is a schematic cross-sectional view illustrating one example of the backlighting device according to the fourth embodiment.

FIG. 18 is a schematic cross-sectional view illustrating one example of the backlighting device according to the fifth embodiment.

FIG. 19 is a schematic cross-sectional view illustrating a conventional direct-lit type lighting device.

FIG. 20 is a schematic cross-sectional view illustrating a configuration in which light is diffused by a diffuser panel and a reflection member of the lighting device shown in FIG. 19.

FIG. 21 is a schematic perspective view illustrating one example in which the reflection member is provided on a board on which a plurality of light emitting elements is arranged in a matrix.

FIG. 22 is a schematic cross-sectional view illustrating a distance between each rim of a corresponding aperture in the reflection member and a light emitting element.

FIG. 23 is a schematic cross-sectional view illustrating a positional relationship between the aperture and the reflection member in an initial state.

FIG. 24 is a distribution map indicating a luminance distribution of the lighting device in the initial state.

FIG. 25 is a schematic cross-sectional view illustrating the positional relationship between the aperture and the reflection member after the lighting device is left under a high-temperature environment.

FIG. 26 is a distribution map indicating a luminance distribution of the lighting device after the lighting device is left under a high-temperature environment.

### DESCRIPTION OF THE PREFERRED EMBODIMENTS

Hereinafter, the embodiments of the present invention are described with reference to the drawings. In the following description, the same components are indicated by the same reference signs, and the appellations and functions are also the same. Therefore, detailed description thereof is omitted.

### First Embodiment

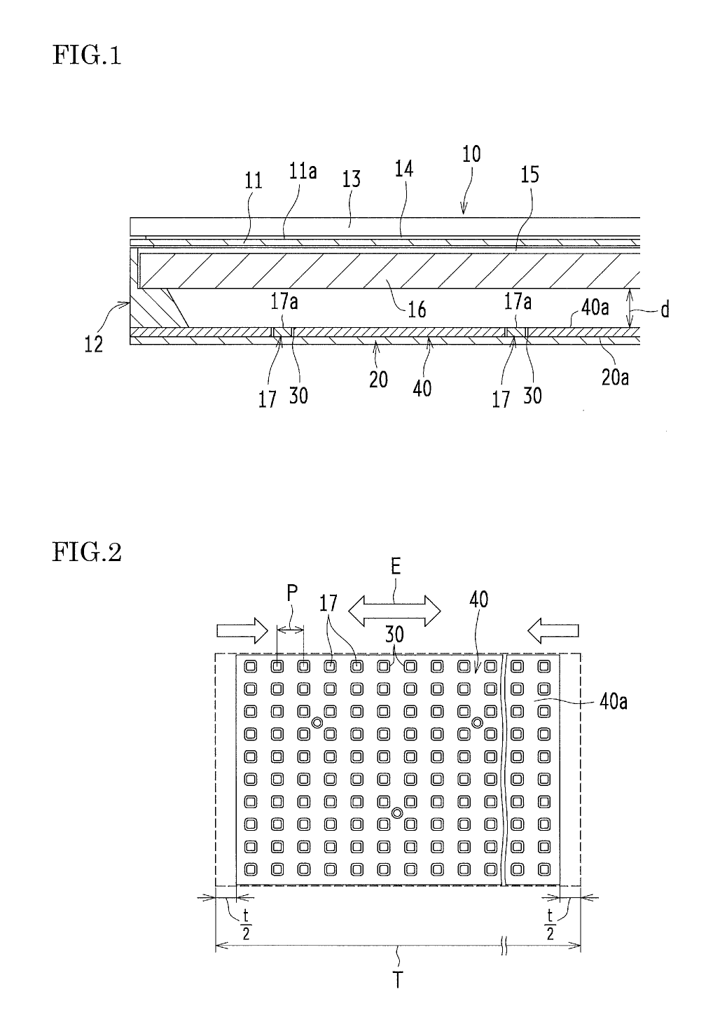

FIG. 1 is a schematic cross-sectional view illustrating a part of a liquid crystal display 10 that is provided with a backlighting device 12 according to the first embodiment. FIG. 2 is an enlarged schematic plan view illustrating the backlighting device 12 shown in FIG. 1, from which an optical element group 15 and a diffuser panel 16 are removed.

As shown in FIG. 1, the liquid crystal display (an example of the display device) 10 has a laterally long rectangular shape as a whole and is horizontally placed in use. In this example, the liquid crystal display 10 has a 12.3-inch display screen used for in-vehicle application. The liquid crystal display 10 includes: a liquid crystal panel 11; and a backlighting device (an example of the lighting device) 12 that illuminates the liquid crystal panel 11 from behind. The shape of the liquid crystal display 10 is not particularly limited. The liquid crystal display 10 may also have a square shape.

Although the detailed configuration of the liquid crystal panel 11 is not shown in the drawings, the liquid crystal panel 11 has the configuration in which: a pair of glass substrates is bonded to each other at a certain gap; and liquid crystal is encapsulated between the glass substrates.

The backlighting device 12, which is a direct-lit type device, is disposed on the opposite side of a display surface 11a of the liquid crystal panel 11. The backlighting device 12 includes: the optical element group 15; the diffuser panel 16; a reflection sheet 40 (an example of the reflection member); and an LED board 20 (an example of the board). The optical element group 15 is made by laminating a plurality of optical sheets so as to have the thickness thinner than the diffuser panel 16, and is arranged between the liquid crystal panel 11 and the diffuser panel 16. The optical element group 15 has a function of converting light that passes through the diffuser panel 16 into planar light. The optical element group 15 is principally constituted of, although not shown in the drawings, a brightness enhancement film and a prism sheet. The diffuser panel 16 is constituted of a plate-like synthetic resin member and light scattering particles dispersed therein, and has a light diffusing function.

The LED hoard 20 is coated with a white resist 20a (specifically, white ink). On the LED hoard 20 coated with the white resist 20a, a plurality of light emitting diodes 17 (an example of light emitting elements, hereinafter referred to as “LEDs 17”) that emits white light is arranged in a matrix at a predetermined specific identical pitch P (about 13 mm in this example) (see FIG. 2). The LEDs 17 emit light from respective light emitting surfaces 17a that are the opposite surfaces of the LED board 20. The LEDs 17 are chip LEDs mounted on the LED board 20 such as a rigid board (for example, a board made of a metallic material such as aluminum to have a rigidity) or a flexible printed board (for example, a board made of a resin material such as polyimide to have a flexibility). The LED board 20 is electrically connected to a power source unit (not shown) controlled by a power source control unit (not shown), via connectors (not shown). A specific voltage is applied from the power source unit and lights up the LEDs 17. The power source control unit performs local dimming control to the power source unit. In this way, the backlighting device 12 illuminates the liquid crystal panel 11 at high luminance and high contrast. All of the LEDs 17 are made in the same shape (the same specification). Typically, the shape of the LEDs 17 in plan view (i.e. the shape of the light emitting surfaces 17a) may be rectangular, square, elliptical, or circular.

The diffuser panel 16 is provided above the LED board 20 at a predetermined specific interval d (about 4 mm in this example) so as to face a surface of the LED board 20 on which the LEDs 17 are mounted. Materials for the diffuser panel 16 include heat-resistant resin materials such as polycarbonate resins and acrylic resins. In this example, the diffuser panel 16 is made of a polycarbonate resin. The interval d between the diffuser panel 16 and the LED board 20 can be determined, for example, depending on a pitch P between the LEDs 17.

The liquid crystal display 10 further includes a transparent protective member 13 provided on the liquid crystal panel 11. The transparent protective member 13 is adhered to the liquid crystal panel 11 via a transparent adhesive member 14 such as a functional film (i.e. an optical clear adhesive (OCA) film). The transparent protective member 13 may be configured by cover glass or a touch panel, and has a function of protecting the display surface 11a of the liquid crystal panel 11.

### (Reflection Sheet)

Here, the reflection sheet 40 is described in detail. The reflection sheet 40 includes a white reflection surface 40a having an excellent light reflectivity. The reflection sheet 40 is provided on the LED board 20 (specifically, on the surface of the LED board 20 on which the LEDs 17 are mounted). The reflection sheet 40 has a plurality of apertures 30. The plurality of apertures 30 in the reflection sheet 40 is each superimposed on a corresponding one of the LEDs 17, and exposes the corresponding LED 17 therethrough (i.e. allows the corresponding LED 17 to project therethrough). The apertures 30 may be shaped according to the shape of the LEDs 17, that is, in the same or substantially the same shape as the LEDs 17. All of the apertures 30 have an identical shape. Materials for the reflection sheet 40 include, for example, PET (polyethylene terephthalate) resins, PP (polypropylene) resins, PVC (polyvinyl chloride) resins, PC (polycarbonate) resins, PMMA (acrylic) resins, and the like. In this example, the reflection sheet 40 is made of a PET resin. The reflection sheet 40 may be subjected to extending process so as to be extended in a predetermined specific extending direction E during manufacture. Here, the extending direction E of the reflection sheet 40 can be confirmed, for example, using an ellipsometer for measuring a change in polarization between the incident light on and the reflected light from the reflection sheet 40. Specifically, considering a phase shift and a difference in optical reflectance between s polarization and p polarization, the change in polarization between the incident light and the reflected light is defined by the phase difference A between s polarization and p polarization and the reflection-amplitude ratio ψ between s polarization and p polarization, and is usually represented as (ψ, Δ).

The backlighting device 12 is required to have heat-resistance under a specific high-temperature environment (for example, a temperature over 60° C.). The reflection sheet 40 thermally shrinks under a specific high-temperature environment that causes heat shrinkage of the reflection sheet 40. In particular, the extended reflection sheet 40 thermally shrinks in the extending direction E under the specific high-temperature environment that causes heat shrinkage of the reflection sheet 40. For example, under a high-temperature environment at 95° C., the reflection sheet 40 made of a PET resin shrinks at a heat shrinkage rate μ of about 0.4%, in a heat shrinkage amount t of about 1.2 mm relative to the total length T, about 300 mm, of the reflection sheet 40 in the extending direction E. In this context, the heat shrinkage rate p is a ratio of the heat shrinkage amount t of the reflection sheet 40 in the extending direction E under the specific high-temperature environment relative to the total length T of the reflection sheet 40 in the extending direction E.

For this reason, the apertures 30 for the LEDs 17 are disposed in the reflection sheet 40 in consideration of the heat shrinkage of the reflection sheet 40. In addition to the heat shrinkage, the apertures 30 are provided also in consideration of a tolerance of the members of the reflection sheet 40, a variation in assembling and a variation in mounting the LEDs 17 on the LED board 20.

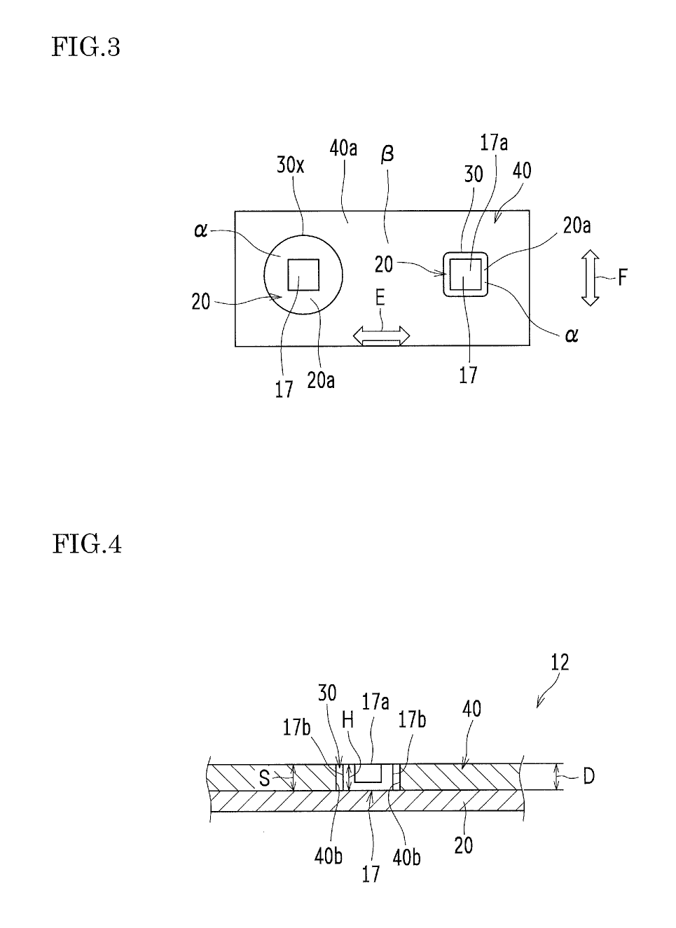

FIG. 3 is a schematic plan view illustrating a difference between apertures formed in a reflection sheet 40, specifically, between an aperture 30x formed unnecessarily large and the aperture 30 that prevents reduction of efficiency in the use of light.

As shown on the left side of the FIG. 3, when the aperture 30x is formed unnecessarily large in the reflection sheet 40, the area of the second reflection region 6 on the reflection sheet 40 is decreased (i.e. the area of the first reflection region a, where the white resist 20a on the LED board 20 is exposed, is increased), which results in less efficiency in the use of light. Here, the optical reflectance in the first reflection region a is about 70 to 80% while the optical reflectance in the second reflection region 6 is about 95% or higher. On the other hand, when the area of the aperture 30 is reduced as much as possible as shown on the right side of FIG. 3, it is possible to prevent reduction in the efficiency in the use of light.

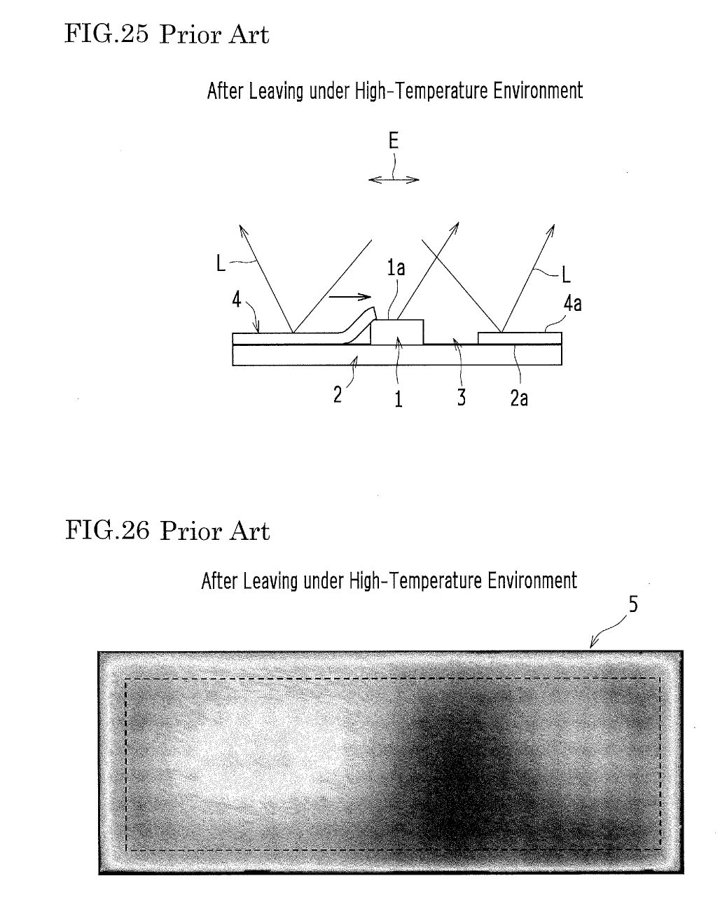

However, when the aperture 30 is formed small in the reflection sheet 40, the reflection sheet 40 thermally shrinks under a high-temperature environment, and thus heat-shrunk reflection sheet 40 may cover the LEDs 17 (see FIG. 25), which may generate luminance unevenness. This problem becomes pronounced in the case in which the reflection sheet 40 is a reflection sheet subjected to extending process so as to be extended in the extending direction E during manufacture.

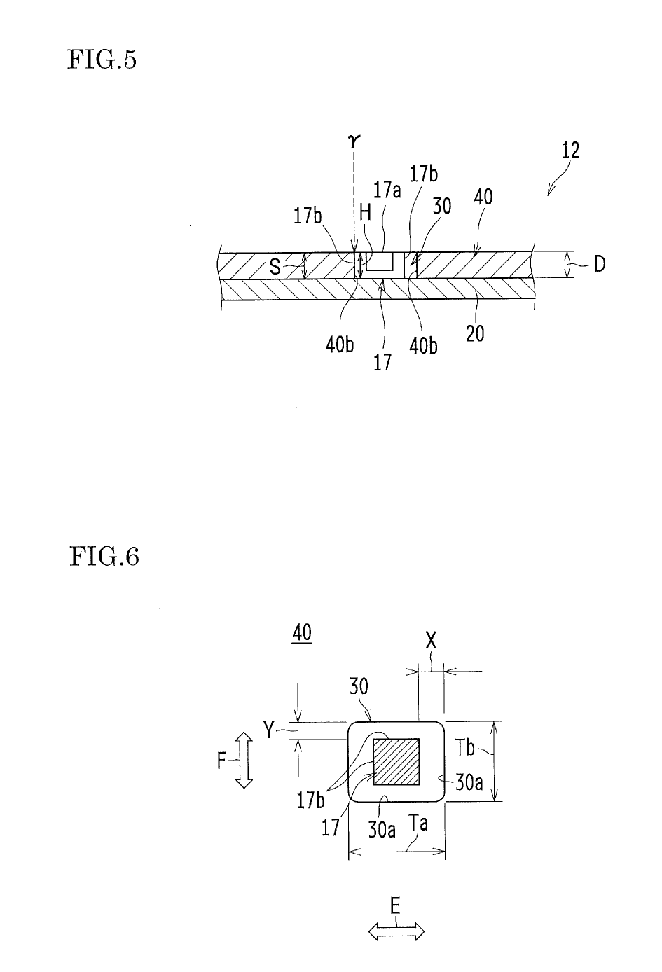

FIG. 4 is a schematic cross-sectional view illustrating a positional relationship between the aperture 30 and the reflection sheet 40 in an initial state in the backlighting device 12 shown in FIG. 1. FIG. 5 is a schematic cross-sectional view illustrating the positional relationship between the aperture 30 and the reflection sheet 40 after the backlighting device 12 shown in FIG. 1 is left under a high-temperature environment.

In this embodiment, as shown in FIGS. 4 and 5, the height size S of the reflection sheet 40 at the part that faces the LED 17 (i.e. the size of the reflection sheet 40 in parallel or substantially in parallel with a side surface 17b) equals or substantially equals the height H of the LED 17.

In this embodiment, the height size S of the reflection sheet 40 at the part that faces the LED 17 equals or substantially equals the height H of the LED 17. Thus, even when the reflection sheet 40 thermally shrinks under a specific high-temperature environment that causes the heat-shrinkage of the reflection sheer 40, it is possible to support a side wall 40b of the reflection sheet 40 that faces the LED 17 by the side surface 17b of the LED 17, which results in effective prevention of the reflection sheet 40 from climbing over the LED 1 (see FIG. 5). In this way, it is possible to prevent the heat-shrunk reflection sheet 40 from covering the light emitting surface 17a of the LED 17. Therefore, even when the reflection sheet 40 thermally shrinks under the specific high-temperature environment, the generation of the luminance unevenness can be effectively reduced, which allows uniform illumination. This is particularly effective in the case in which the reflection sheet 40 is a reflection sheet subjected to extending process so as to be extended in the extending direction E during manufacture.

Also, since the reflection member is the reflection sheet 40, it is possible to easily realize the configuration capable of improving the efficiency in the use of light using inexpensive components.

In this embodiment, the thickness D (height size S) of the reflection sheet 40 equals or substantially equals the height of the LED 17. In this way, it is possible to use the reflection sheet 40 having a constant thickness D, which contributes to reduction in costs for the reflection sheet 40.

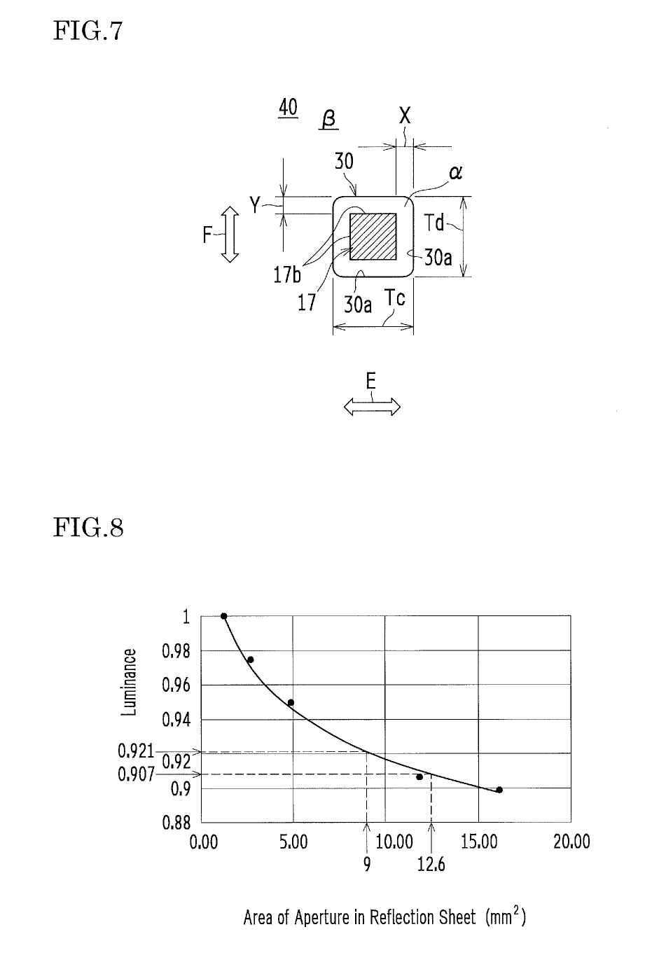

FIG. 6 is a schematic plan view illustrating one example of the aperture 30 in which a first distance X in the extending direction E of the reflection sheet 40 is larger than a second distance Y in the orthogonal direction F of the reflection sheet 40. FIG. 7 is a schematic plan view illustrating one example of the aperture 30 in which the first distance X in the extending direction F of the reflection sheet 40 equals or substantially equals the second distance Y in the orthogonal direction F of the reflection sheet 40.

Taking into account the heat shrinkage of the reflection sheet 40 extended in the extending direction E, the positional relationship between the aperture 30 in reflection sheet 40 and the LED 17 should meet the expression X>Y, where X represents the first distance between a ruin 30a of the aperture 30 in the reflection sheet 40 and the side surface 17b of the LED 17 positioned within the aperture 30 in the extending direction E, and Y represents the second distance between the rim 30a of the aperture 30 and the side surface 17b of the LED 17 positioned within the aperture 30 in the orthogonal direction F that is orthogonal to the extending direction E (see FIG. 6).

More specifically, in addition to the heat shrinkage in the extending direction E, taking into account a variation in adhesion of the reflection sheet 40, a tolerance of the members, a tolerance in mounting the LED 17 and the like, it is preferable that X and Y meet the following expression (1):

X≥1.65×Y (1).

However, when the height size S of the reflection sheet 40 at the part that faces the LED 17 is set in conformity with or substantially in conformity with the height H of the LED 1 the tolerance of the reflection sheet 40 in the extending direction E can be ignored. Thus, the first distance X can equal or substantially equal the second distance Y (see FIG. 7). Therefore, the area of the aperture 30 in the reflection sheet 40 meets the following expression (2), where the lengths of the aperture 30 shown in FIG. 6 in the extending direction E and the orthogonal direction F are respectively represented as Ta and Tb, and the lengths of the aperture 30 shown in FIG. 7 in the extending direction E and the orthogonal direction F are respectively represented as Tc and Td:

(Ta×Tb)>(Tc×Td) (2).

Here, (Ta×Tb) is an area of the aperture that is set in consideration of the heat shrinkage of the reflection sheet 40 while (Tc×Td) is an area of the aperture when the height H of the LED 17 is in conformity with or substantially in conformity with the thickness D of the reflection sheet 40.

Therefore, when the height H of the LED 17 is in conformity with or substantially in conformity with the thickness D of the reflection sheet 40 (see FIG. 7), the area of the aperture 30 in the reflection sheet 40 can be reduced. Thus, it is possible to improve the efficiency in the use of light.

In this way, by setting the height H of the LED 17 in conformity with or substantially in conformity with the thickness D of the reflection sheet 40, it is possible to support the end surface of the reflection sheet 40 by the side surface 17b (side wall) of the LED 17 even when the reflection sheet 40 thermally shrinks under the specific high-temperature environment, without taking account into the size tolerance of the aperture 30 in the reflection sheet 40 in the case of considering the heat shrinkage in the extending direction E. Thus, it is possible to prevent the covering of the LED 17, which contributes to reduction in luminance unevenness.

FIG. 8 is a graph indicating a correlation between the area of the aperture 30 in the reflection sheet 40 and the brightness (luminance). FIG. 8 exemplarily shows the case in which the LED 17 having a size of 2.5 mm in length by 2.5 mm inn width is used. The horizontal axis of the graph indicates the area of the aperture 30 in the reflection sheet 40 while the vertical axis indicates the luminance.

As shown in FIG. 8, as the area of the aperture 30 in the reflection sheet 40 increases, the luminance decreases. That is, as the aperture 30 in the reflection sheet 40 is made small as much as possible, the luminance is improved.

Therefore, it is possible to increase the second reflection region 6 on the reflection sheet 40 (i.e. it is possible to reduce the first reflection region a where the white resist 20a on the LED board 20 is exposed) by setting the thickness D of the reflection sheet 40 in conformity with or substantially in conformity with the height of the LED 17 so as to reduce the area of the aperture 30 relative to the LED 17. Thus, the efficiency in the use of light can be improved and the luminance is raised.

For example, in the case in which the LED 17 having the size of 2.5 mm in length by 2.5 mm in width is used, when the aperture 30 is set so as to have the size of 3 mm in length by 4.2 mm in width, the area of the aperture 30 is 12.6 mm², and the luminance is 0.907 as can be seen from the graph in FIG. 8. Also, when the aperture 30 is set so as to have the size of 3 mm in length by 3 mm in width, the area of the aperture 30 is 9 mm², and the luminance is 0.921 as can be seen from the graph in FIG. 8. Therefore, in the case in which the LED 17 having the size of 2.5 mm in length by 2.5 mm in width is used, when the aperture 30 is set so as to have the size of 3 mm in length by 3 mm in width, the luminance can be improved by 1.5% compared to the case inn which the aperture 30 is set so as to have the size of 3 mm in length by 4.2 mm in width.

In this embodiment, in addition to improvement of the efficiency in the use of light depending on the area of the aperture 30 in the reflection sheet 40 as described above, it is also possible to improve the efficiency in the use of light by setting the height H of the LED 17 in conformity with or substantially in conformity with the thickness D of the reflection sheet 40.

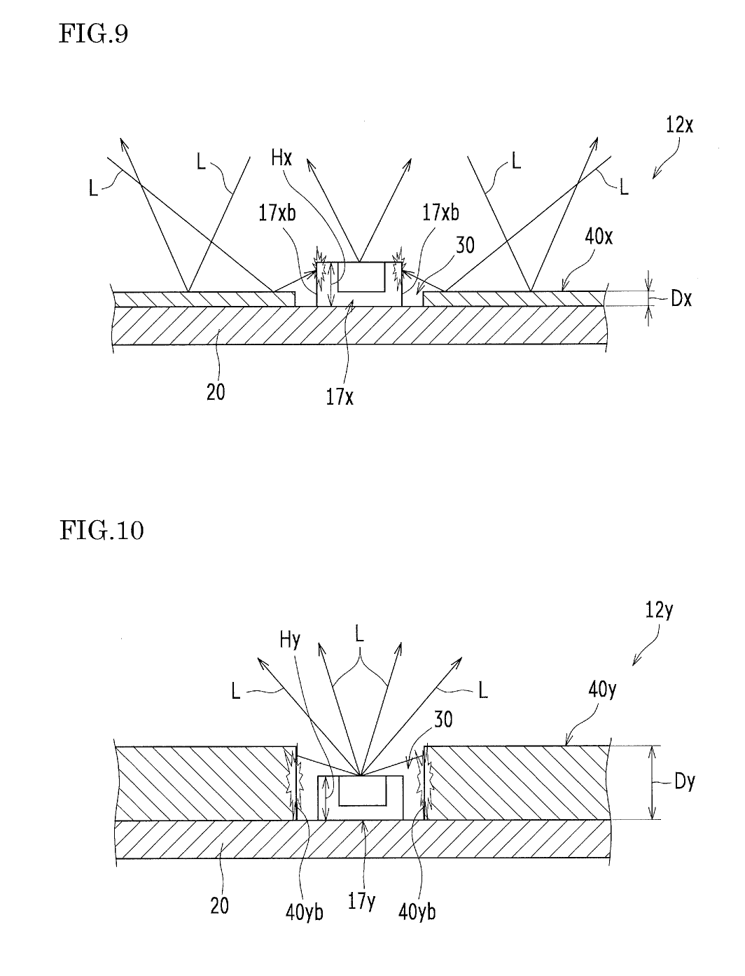

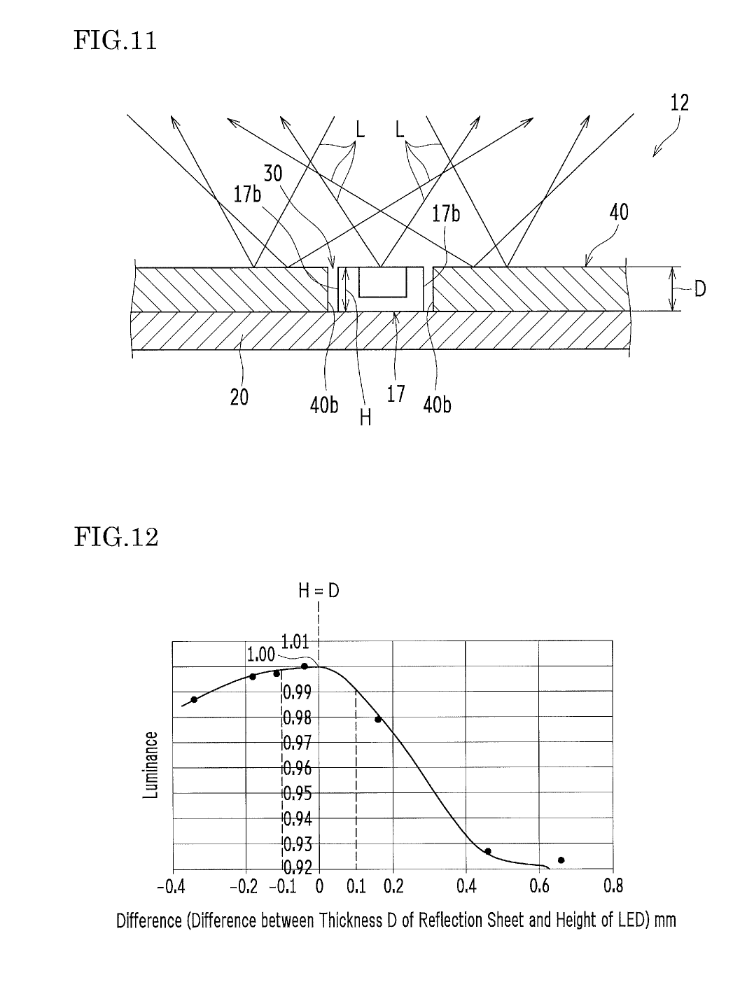

FIG. 9 is a schematic cross-sectional view illustrating a configuration as one example in which the thickness Dx of a reflection sheet 40x is made smaller than the height Hx of an LED 17x. FIG. 10 is a schematic cross-sectional view illustrating a configuration as one example in which the thickness Dy of a reflection sheet 40y is made larger than the height Hy of an LED 17y. FIG. 11 is a schematic cross-sectional view illustrating a configuration as one example in which the thickness D of the reflection sheet 40 is equal to or substantially equal to the height H of the LED 17.

As shown in FIG. 9, the thickness Dx of the reflection sheet 40x of a generally used direct-lit type backlighting device 12x is smaller than the height Hx of the LED 17x. Thus, part of the light L reflected by the reflection sheet 40x is absorbed by side surfaces 17xb (side walls) of the LED 17x, which deteriorates the efficiency in the use of the light L. On the other hand, as shown in a direct-lit type backlighting device 12y in FIG. 10, when the thickness Dy of the reflection sheet 40y is larger than the height Hy of the LED 17y, the light L emitted from the LED 17y is absorbed by end surfaces 40yb of the reflection sheet 40y, which deteriorates the efficiency in the use of the light L as well as the directivity of the light L of the LED 17y.

In contrast to the above cases, in the backlighting device 12 as shown in FIG. 11, when the height H of the LED 17 is set in conformity with or substantially in conformity with the thickness D of the reflection sheet 40, the light L is absorbed neither by the side surfaces 17b (side walls) of the LED 17 nor by the side walls 40b of the aperture 30 in the reflection sheet 40. Thus, it is possible to avoid deterioration in the efficiency in the use of the light L and furthermore in the directivity of the light L.

Also, the thickness D of the reflection sheet 40 is 0.5 mm or more (D≥0.5 mm). Thus, it is possible to obtain rigidity of the reflection sheet 40 to a certain extent, which leads to effective prevention of bending of the reflection sheet 40.

FIG. 12 is a graph indicating a correlation among the thickness D of the reflection sheet 40, the height II of the LED and the brightness (luminance). In FIG. 12, the horizontal axis indicates the difference between the thickness D of the reflection sheet 40 and the height of the LED 17, and the vertical axis indicates the luminance corresponding to the difference.

The point “0 mm” on the horizontal axis is a case where the height H of the LED 17 equals the thickness D of the reflection sheet 40, and at this point, it can be also seen that the luminance has a maximum value. Therefore, as can be seen from the graph in FIG. 12, the relationship between the thickness D [mm] of the reflection sheet 40 and the height H [mm] of the LED 17 meets preferably the following expression (3) to keep the decreasing rate of luminance within 1%:

H−0.1[mm]≤D≤H+0.1[mm] (3).

In this way, it is possible to ensure the brightness (luminance) of the light L emitted from the backlighting device 12.

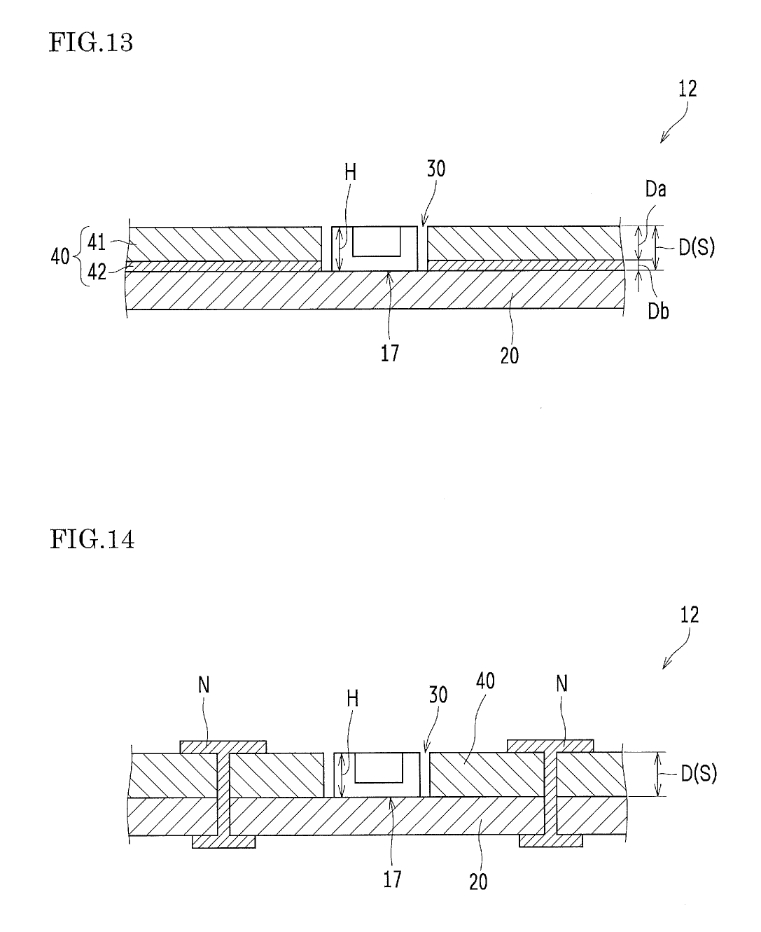

FIGS. 13 and 14 are schematic cross-sectional views respectively illustrating one example and another example of the configuration in which the reflection sheet 40 is fixed to the LED board 20.

Examples of the configuration in which the reflection sheet 40 is fixed to the LED board 20 include: a configuration in which a reflection sheet body 41 is fixed to the LED board 20 using an adhesive member 42 such as a double sided adhesive sheet (so-called double sided tape) or an adhesive (see FIG. 13); and a configuration in which the reflection sheet 40 is fixed to the LED board 20 using a fixing member N such as rivets (see FIG. 14).

Out of the above-described configurations, when the reflection sheet body 41 is fixed to the LED board 20 using the adhesive member 42 as shown in FIG. 13, the reflection sheet 40 is constituted of the reflection sheet body 41 and the adhesive member 42. Thus, the thickness D of the reflection sheet 40 is indicated by the expression D=Da+Db, where Da represents the thickness of the reflection sheet body 41 and Db represents the thickness of the adhesive member 42.

That is, the reflection sheet 40 has the thickness D (height size S) equal to or substantially equal to the height H of the LED 17 by including the adhesive member 42 (for example, the double sided adhesive sheet or the adhesive) that is interposed between the reflection sheet body 41 and the LED board 20. With this configuration, when the reflection sheet body 41 is adhered to the LED board 20 via the adhesive member 42, the thickness D (height size S) of the reflection sheet 40 can be set in conformity with or substantially in conformity with the height H of the LED 17. Therefore, even when the reflection sheet 40 thermally shrinks under the specific high-temperature environment, it is possible to effectively prevent generation of the luminance unevenness, which contributes to uniform illumination.

### Second Embodiment

If the thickness D of the reflection sheet 40 is larger than the height H of the LED 17, the travel of the light L is obstructed by part of the side surface of the aperture 30 in the reflection sheet 40, which protrudes higher than the LED 17. Thus, the light L is likely to be absorbed and the efficiency in the use of the light L is degraded.

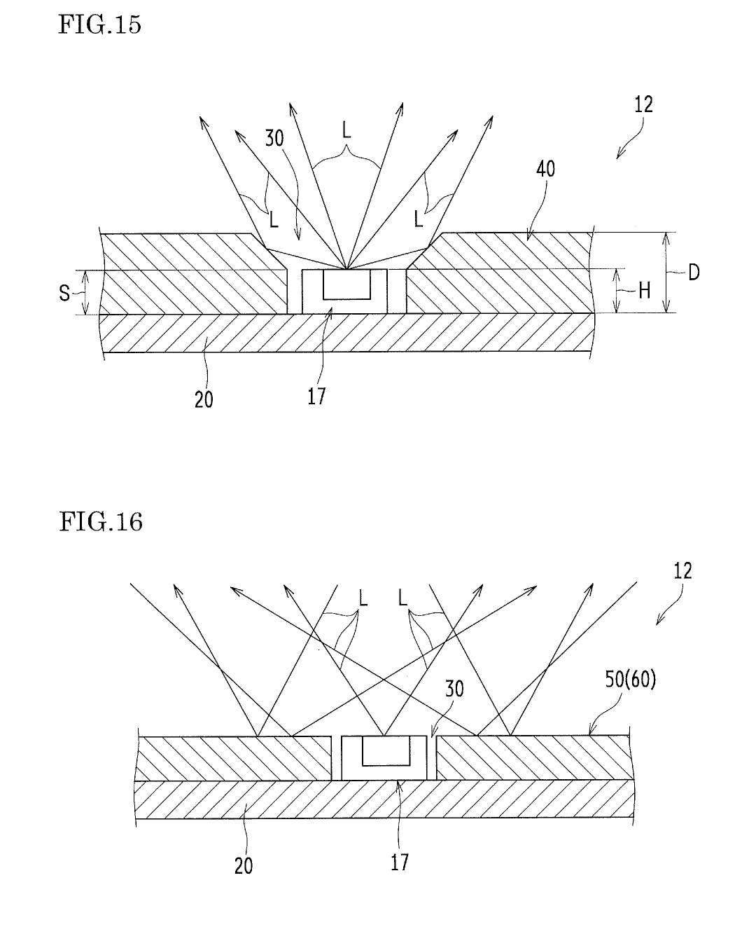

FIG. 15 is a schematic cross-sectional view illustrating one example of the backlighting device 12 according to the second embodiment. In the backlighting device 12 according to the second embodiment, an end part of the aperture 30 in the reflection sheet 40, which is an opposite end of the LED board 20 (i.e. the side surface protruding higher than the LED 17), has an inversed tapered shape (inclined structure) in which the area of the aperture 30 gradually increases toward the direction opposite to the LED board 20, as shown in FIG. 15.

Thus, when the thickness D of the reflection sheet 40 is larger than the height H of the LED 17, the end part of the aperture 30 in the reflection sheet 40 that is opposite to the LED board 20 is made to have the inversed tapered shape (inclined structure). Thus, the light L can be easily reflected outside by the part having the inversed tapered shape (inclined part). Thus, it is possible to reduce the absorption of the light L by the side surface of the aperture 30 in the reflection sheet 40, which can prevent reduction in the efficiency in the use of the light L. Also, since the height size S of the lowermost surface of the inversed tapered shape of the reflection sheet 40 (i.e. the surface corresponding to the light emitting surface 17a of the LED 17) is the same or substantially the same as the height H of the LED 17, it is possible to reduce the influence caused by the heat shrinkage of the reflection sheet 40.

### Third Embodiment

In the first embodiment and the second embodiment, the reflection sheet 40 is used as the reflection member. However, it is possible to use a reflection panel in place of the reflection sheet 40.

FIG. 16 is a schematic cross-sectional view illustrating one example of the backlighting device 12 according to the third embodiment. In the backlighting device 12 according to the third embodiment, a reflection panel 50 is used as a reflection member 60 in place of the reflection sheet 40, as shown in FIG. 16. As the reflection panel 50, a material having the optical reflectance similar to that of the reflection sheet 40 can be used. For example, extrusion molded materials such as PC (polycarbonate) resins can be used. In this case, since the extrusion molded material is not extended, it is possible to prevent the heat shrinkage.

### Fourth Embodiment

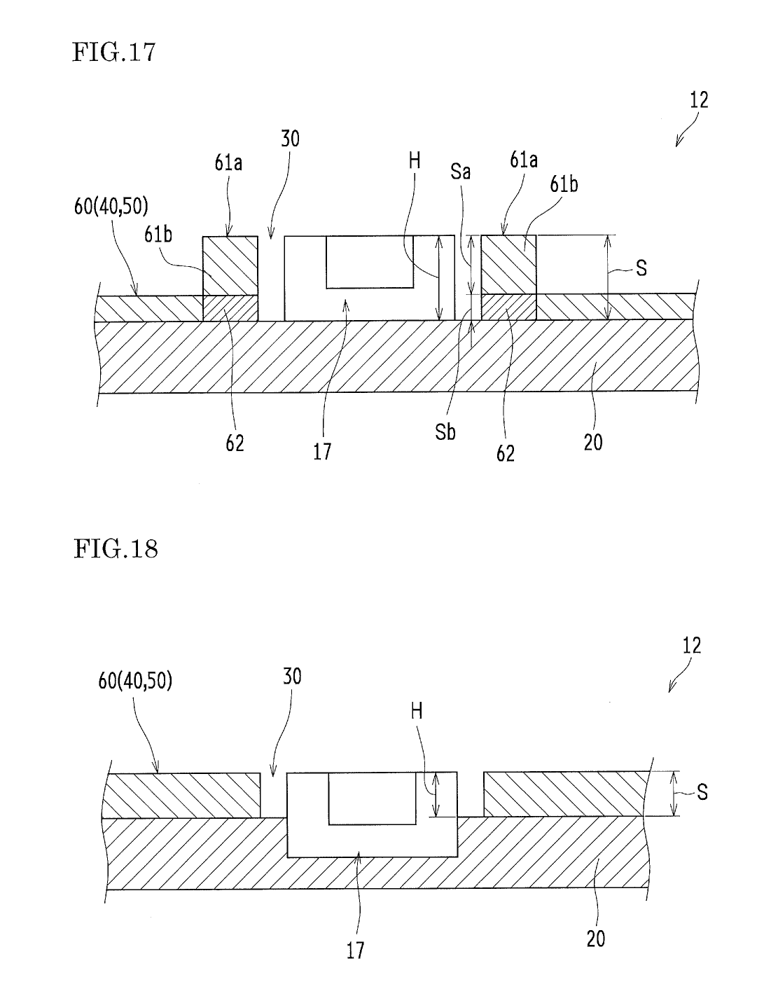

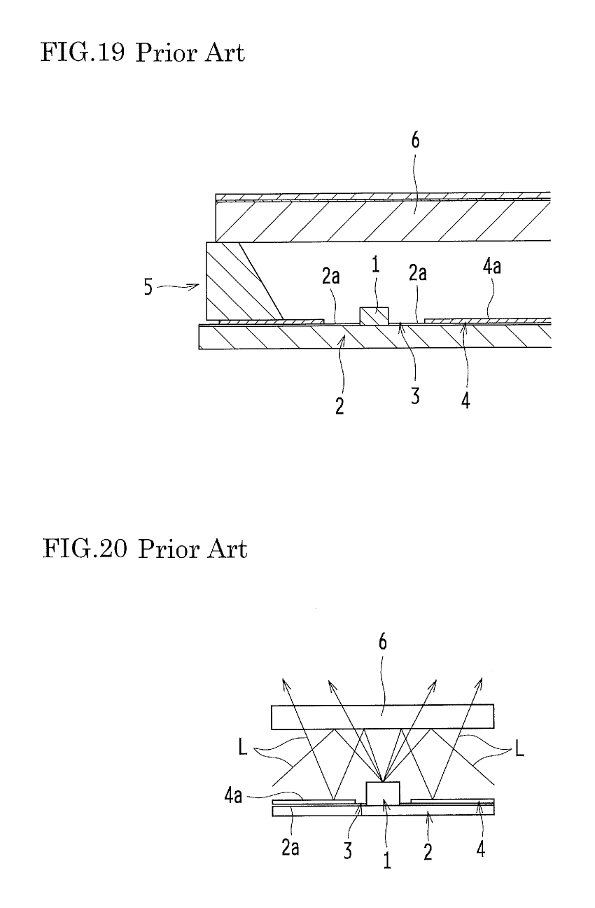

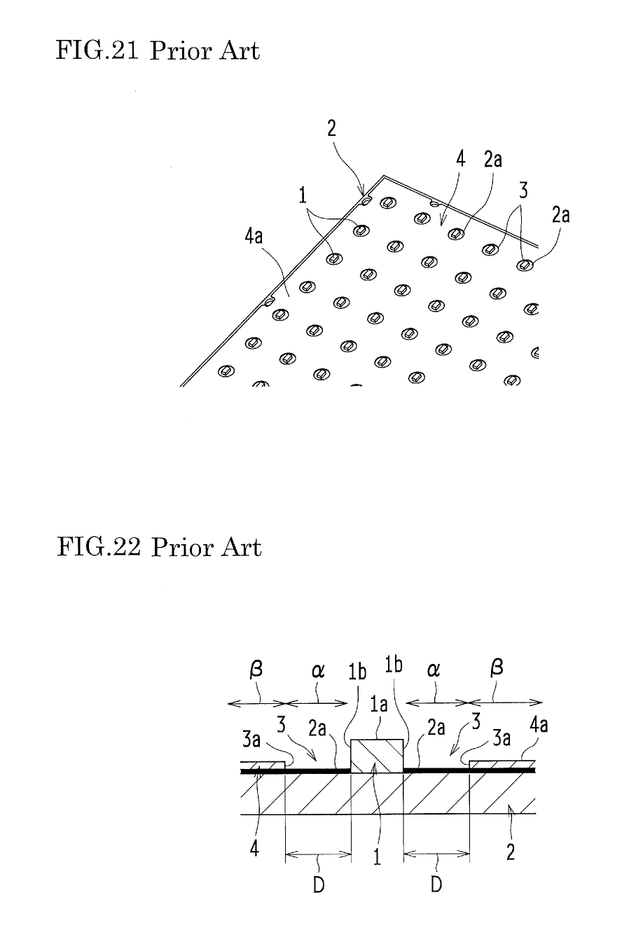

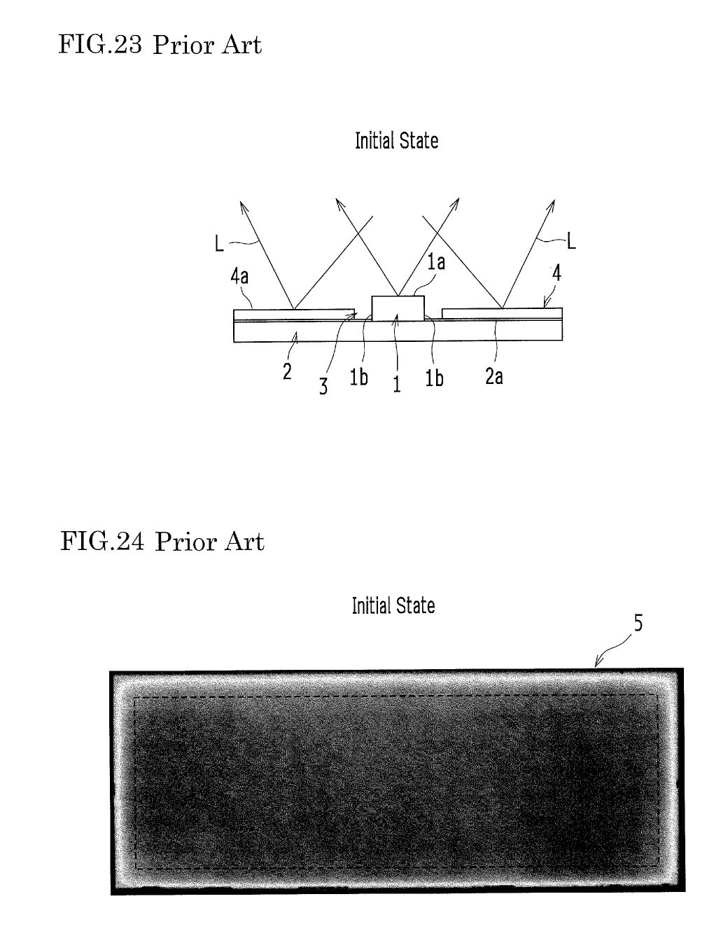

FIG. 17 is a schematic cross-sectional view illustrating one example of the backlighting device 12 according to the fourth embodiment. In the reflection member 60 (for example, the reflection sheet 40 and the reflection panel 50) of the backlighting device 12 according to the fourth embodiment, the height size S of only a peripheral part 61a that surrounds the aperture 30 equals or substantially equals the height H of the LED 17, as shown in FIG. 17.

In the reflection member 60 around the LED 17 of the backlighting device 12 according to the fourth embodiment, only the part adjacent to the region of the aperture 30 (i.e. the peripheral part 61a) can be set in conformity with or substantially in conformity with the height H of the LED 17. In this example, the peripheral part 61a is constituted of a body part 61b and an adhesive member 62. Thus, the height size S of the peripheral part 61a satisfies the expression S=Sa+Sb, where Sa represents the height size of the body part 61b and Sb represents the thickness of the adhesive member 62.

That is, the peripheral part 61a has the height size S equal to or substantially equal to the height H of the LED 17 by including the adhesive member 62 (for example, the double sided adhesive sheet or the adhesive) that is interposed between the peripheral part 61a and the LED board 20.

### Fifth Embodiment

FIG. 18 is a schematic cross-sectional view illustrating one example of the backlighting device 12 according to the fifth embodiment. In the backlighting device 12 according to the fifth embodiment, the LED 17 is embedded in the LED board 20, as shown in FIG. 18.

In the backlighting device 12 according to the fifth embodiment, it is possible to reduce the height H of the LED 17 from the surface of the LED board 20 on which the reflection member 60 is disposed. Thus, the height size S of the part of the reflection member 60 (for example, the reflection sheet 40 and the reflection panel 50), which faces the LED 17, can be set equal to or substantially equal to the height H of the LED 17 from the surface of the LED board 20 on which the reflection member 60 is disposed.

The present invention should not be limited to the above-described embodiments and may be embodied in various other forms. Therefore, the above-described embodiments are to be considered in all respects as illustrative and not restrictive. The scope of the invention is indicated by the appended claims rather than by the foregoing description. All modifications and changes that come within the equivalency range of the appended claims are intended to be embraced therein.

What is claimed is:

1. A lighting device comprising:
a board on which a plurality of light emitting elements arranged in a matrix; and
a reflection member provided on the board and having a plurality of apertures, the plurality of apertures each being superimposed on a corresponding one of the plurality of light emitting elements, wherein
parts of the reflection member, which face respectively the plurality of light emitting elements, have a height size that is equal to or substantially equal to a height of the plurality of light emitting elements.

2. The lighting device according to claim 1, wherein
a thickness of the reflection member equals or substantially equals the height of the plurality of light emitting elements.

3. The lighting device according to claim 1, wherein
the following expression is satisfied:
H−0.1[mm]≤D≤H+0.1[mm],
where a thickness of the reflection ember is represented as D [mm], and the height of the plurality of light emitting elements is represented as H [mm].

4. The lighting device according to claim 1, wherein
the reflection member has a height size that is equal to or substantially equal to the height of the plurality of light emitting elements by including an adhesive member that is interposed between the reflection member and the board.

5. The lighting device according to claim 1, wherein
a thickness of the reflection member is larger than the height of the plurality of light emitting elements, and
an end part of each of the plurality of apertures in the reflection member, which is opposite to the board, is formed so as to have an inversed tapered shape in which an area of the corresponding aperture gradually increases toward a direction opposite to the board.

6. The lighting device according to claim 1, wherein
the reflection member is a reflection sheet.

7. The lighting device according to claim 6, wherein
the reflection sheet is extended in a predetermined specific extending direction.

8. The lighting device according to claim 1, wherein
the reflection member is a reflection panel.

9. The lighting device according to claim 1, wherein
a height size of only a peripheral part of the reflection member surrounding each of the plurality of apertures equals or substantially equals the height of the plurality of light emitting elements.

10. The lighting device according to claim 1, wherein
the plurality of light emitting elements is embedded in the board.

11. A display device comprising the lighting device according to claim 1.
